(19) United States
(12) Patent Application Publication
(10) Pub. No.: US 2006/0102002 A1
(43) Pub. Date: May 18, 2006

(54) Cleaning unit for wet type air cleaner

(75) Inventor: Woong Kim, Seoul (KR)

Correspondence Address: BACON & THOMAS, PLLC, 625 SLATERS LANE, FOURTH FLOOR, ALEXANDRIA, VA, 22314, US

(73) Assignee: DAEWOO ELECTRONICS Corporation, Seoul (KR)

(21) Appl. No.: 11/272,672

(22) Filed: Nov. 15, 2005

(30) Foreign Application Priority Data
Nov. 17, 2004 (KR) 10-2004-0094298
Nov. 17, 2004 (KR) 10-2004-0094300

(51) Int. Cl. B01D 47/00

(52) U.S. Cl. 96/283

(57) ABSTRACT

A cleaning unit for a wet type air cleaner includes a blowing unit rotatably installed in a housing containing therein water, for introducing indoor air toward the water; a guide extended from a lower end of the blowing unit into the water, for supplying the indoor air into the water; and a plurality of ribs provided at an inner surface of the guide, for dispersing the water in the housing by a centrifugal force of the blowing unit. The blowing unit and the guide are rotated as a unit, and a contact area between the water upwardly moved by the ribs in the guide and the indoor air introduced by the blowing unit becomes maximum.

### FIELD OF THE INVENTION

The present invention relates to a wet type air cleaner; and, more particularly, to a cleaning unit for the wet type air cleaner, which is installed at a portion containing water in the wet type air cleaner to transfer indoor air into the water, so that toxic substances in the indoor air can be adsorbed by the water due to the contact between the indoor air and the water and, further, the air to be discharged into a room can contain a proper amount of moisture.

### BACKGROUND OF THE INVENTION

In general, an air cleaner serves to purify indoor air containing fine dusts, various noxious gases, various germs, molds, viruses, etc., by using a purification medium. Such an air cleaner can be used through all seasons because it has various functions of removing unpleasant odors and small particles such as ticks, pollen and furs of pets, preventing an outbreak of disease due to an aerial infection, and so forth as well as its principal function of maintaining indoor air clean and pleasant.

Air cleaners can be largely classified into two types: dry type and wet type. Dry type air cleaners can be divided again into a filter type and an electric dust collection type.

Here, the electric dust collection type uses no filter, so it has a merit in that there is no need to replace filters. However, if dusts are accumulated on an electric dust collecting plate, purifying efficiency of the air cleaner will be deteriorated, and dust removing capacity thereof will also be undermined.

As for the filter type air cleaner, on the other hand, since various fine particles are captured while air passes through filters, the filter type air cleaner exhibits a high purifying efficiency, and thus is adequate for use in a season when yellow dust comes. However, since the filters need to be replaced periodically, maintenance cost thereof is high.

Meanwhile, a wet type air cleaner employs a method for making floating particles in suctioned air deposited in water by allowing the suctioned air to contact water. Though the wet type air cleaner has not been commonly utilized yet, it has many advantages in that it does not requires a replacement of filters and generates little noise, while providing a humidifying function as well. Thus, for children, its use is preferred. However, when using the wet type air cleaner, water should be replaced or replenished, which would be rather cumbersome.

In order to solve the above-mentioned problems, there is suggested a wet type air cleaner having a simple structure in which water is stored in a certain space, and a blower unit and a water spray unit are installed in a same space. One of such wet type air cleaners is disclosed in Japanese Patent Laid-open Publication No. 2000-334240, entitled “WET TYPE AIR CLEANER”.

The wet type air cleaner includes an air circulation passage through which air is introduced into the inside of the air cleaner and then is outputted to the outside after being purified. A reservoir containing therein liquid to be sprayed is formed in a part of the air circulation passage. The air cleaner further includes a blower unit for allowing the air to be circulated through the air circulation passage and a spray unit for spraying the liquid into a spray space in the reservoir.

The blower unit includes a fan for suctioning the air into the spray space and a motor for driving the fan. The spray unit includes a pump for pumping up the liquid from the reservoir and a nozzle for spraying the liquid into the spray space.

Further, the air supplied into the air circulation passage typically flows downward after being introduced into the reservoir from upside, whereas the liquid is sprayed upward from down-side. Therefore, the air introduced into the reservoir is brought into contact with fine liquid particles sprayed by the nozzle, thereby allowing noxious substances in the air to be adsorbed by the liquid.

In the aforementioned conventional wet type air cleaner, however, droplets containing collected dirt particles are discharged to the outside air of the air cleaner with a flow of clean air and, thus, a cleaning effect deteriorates. Further, a humidity level increases more than a set value, which dissatisfies users.

Moreover, in the conventional wet type air cleaner, water is injected on a wall surface of the product to collect dirt or the like, thereby increasing an operating noise.

In order to enhance the cleaning effect, a contact area of air containing injected water, dirt or the like needs to be increased. However, a comparatively small contact area between air and water deteriorates the cleaning effect.

### SUMMARY OF THE INVENTION

It is, therefore, a primary object of the present invention to provide a cleaning unit for a wet type air cleaner, capable of maximizing a negative ion generating effect as well as an air cleaning function by way of increasing a contact area between water particles and air and also capable of overcoming drawbacks in that since droplets containing collected dirt particles are discharged to outside air of the air cleaner with a clean air flow, a cleaning effect deteriorates and a humidity level increases above a set value.

It is another object of the present invention to provide a cleaning unit for a wet type air cleaner, capable of more effectively adsorbing toxic substances due to a second contact between air discharged from the water and the cleaning air dispersed sideways by improving a structure of a circumferential surface corresponding to a surface of the water.

It is still another object of the present invention to provide a cleaning unit for a wet type air cleaner, capable of reducing a noise generated during an air cleaning operation by sending indoor air introduced into the air cleaner into the water such that the cleaning water and the air can be contacted without colliding on a side-wall of the air cleaner.

In accordance with the present invention, there is provided a cleaning unit for a wet type air cleaner, including: a blowing unit rotatably installed in a housing having therein water, for introducing indoor air toward the water; a guide extended from a lower end of the blowing unit into the water, for supplying the indoor air into the water; and a plurality of ribs provided at an inner surface of the guide, for dispersing the water in the housing by a centrifugal force of the, blowing unit, wherein the blowing unit and the guide are rotated as a unit, and a contact area between the water upwardly moved by the ribs in the guide and the indoor air introduced by the blowing unit becomes maximum.

### BRIEF DESCRIPTION OF THE DRAWINGS

The above and other objects and features of the present invention will become apparent from the following description of preferred embodiments, given in conjunction with the accompanying drawings, in which:

FIG. 1 shows a cross sectional view of a cleaning unit in accordance with a first preferred embodiment of the present invention;

FIG. 2 describes a cross sectional view of a cleaning unit in accordance with a second preferred embodiment of the present invention;

FIG. 3 provides a top view of cleaning units in accordance with a third preferred embodiment of the present invention;

FIG. 4 represents a cross sectional view of a cleaning unit in accordance with a fourth preferred embodiment of the present invention; and

FIG. 5 offers a perspective view of the cleaning unit in accordance with the fourth preferred embodiment of the present invention.

### DETAILED DESCRIPTION OF THE PREFERRED EMBODIMENTS

Hereinafter, preferred embodiments of a cleaning unit for a wet type air cleaner in accordance with the present invention will be described in detail with reference to the accompanying drawings.

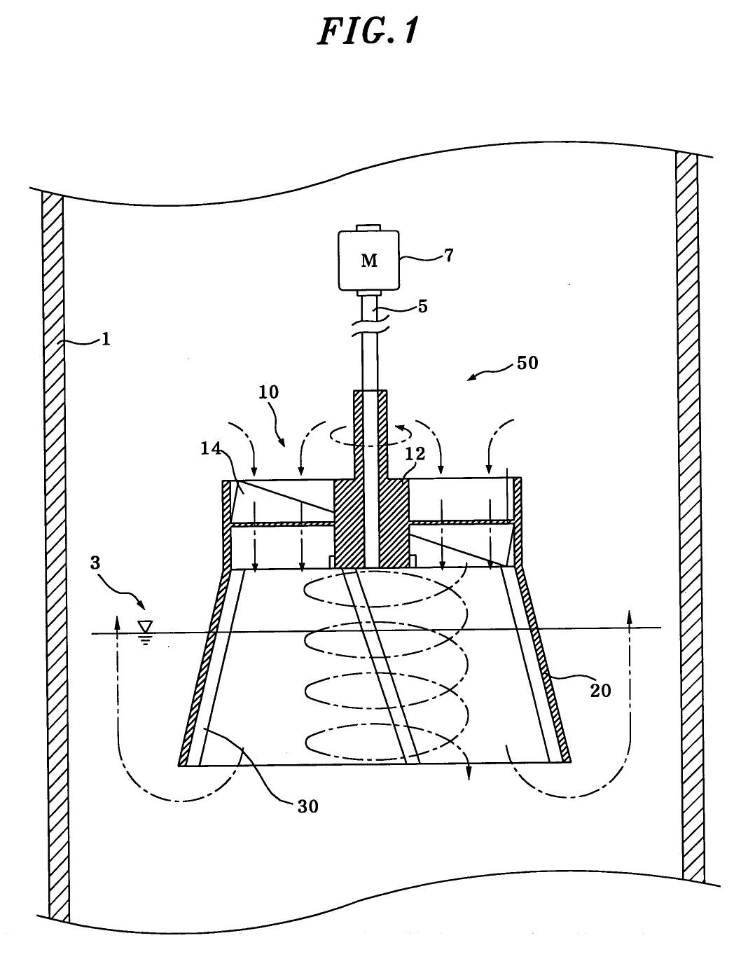

FIG. 1 shows a cross sectional view of a cleaning unit in accordance with a first preferred embodiment of the present invention.

A cleaning unit 50 includes a blowing unit 10 rotatably installed in a housing 1 containing therein water 3, the housing 1 being provided with air inlets (not shown) and air outlets (not shown), for transferring indoor air introduced through air inlets toward the water 3; a guide 20 extended from a lower end of the blowing unit 10 into the water 3, for supplying the indoor air introduced into the housing 1 into the water 3; and a plurality of ribs 30 formed on an inner surface of the guide 20, for upwardly dispersing the water 3 by the rotation of the guide 20.

As shown in FIG. 1, the blowing unit 10 is spaced from a water level at a predetermined distance, so that the indoor air introduced through the air inlets of the housing 1 can be transferred to the water 3, resulting in a maximized contact area between the indoor air and the water 3.

Further, the blowing unit 10 has a fan 14 installed on a circumferential surface of a rotating engagement 12. Further, a rotation shaft 5 and a motor 7 are installed at the rotating engagement 12, and these serve as components of the blowing unit 10 for introducing indoor air into the housing 1. In case a capacity of the air cleaner is smaller than or equal to a predetermined level, if the indoor air is circulated by the blowing unit 10 without an additional blowing unit, the number of components can be reduced. Furthermore, in addition to the blowing unit 10, another blowing unit can be connected to the rotation shaft 5.

The hollow cylindrical guide 20 is downwardly extended from an outer end portion of the fan 14 and has an inner cross sectional area changing in a longitudinal direction, wherein the guide 20 preferably has an upper portion narrower than a lower portion thereof.

As illustrated in FIG. 1, each of the rib 30 formed of a spiral protrusion is disposed at an inner surface of the guide 20. Therefore, if the guide 20 rotates, the water in the guide 20 is upwardly transferred along the inclined surface of the rib 30 and then contacted with the downwardly transferred indoor air. Accordingly, toxic substances can be more effectively adsorbed.

The indoor air transferred to the water by the fan 14 is introduced into the water along the guide, and generates gas bubbles in the water. At this time, foreign substances in the air are adsorbed by the water, and the air discharged to an outside of the water 3 circulates into a room through air outlets of the housing 1.

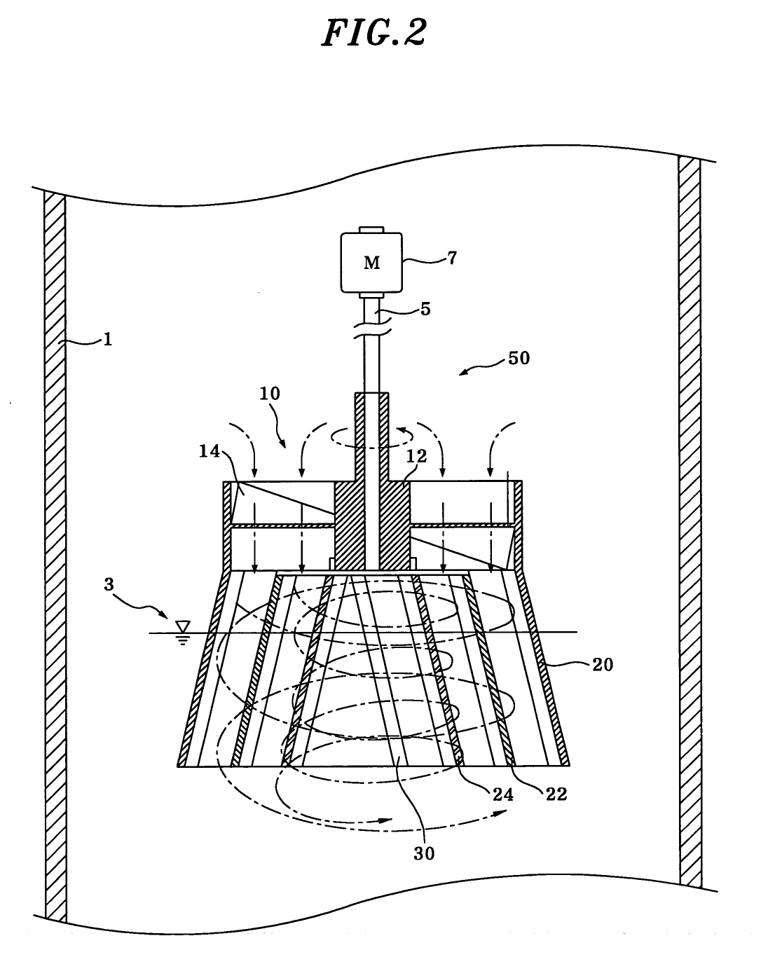

FIG. 2 illustrates a cross sectional view of the cleaning unit 50 in accordance with a second preferred embodiment of the present invention.

As same as the first preferred embodiment, the second preferred embodiment of the present invention includes the blowing unit 10, the guide 20 and the ribs 30. However, the second preferred embodiment is characterized by the guide 20. Specifically, in the second preferred embodiment, a plurality of guides is installed at regular intervals while being overlapped with each other and, thus, paths for transferring air are formed.

Hereinafter, the second preferred embodiment of the present invention will be described with reference to FIG. 2. A second guide 22 having a diameter comparatively smaller than that of the guide 20 is installed at an inner portion of the guide 20, and a third guide 24 whose diameter is comparatively smaller than that of the second guide 22 is installed at an inner portion of the second guide 22. Thus, paths are formed between the guide 20 and the second guide 22 and between the second guide 22 and the third guide 24, and an additional path is formed in the third guide 24. Accordingly, the air downwardly transferred by the fan 14 downwardly moves in a spiral shape along the path without generating a whirlpool. As a result, a speed of blowing air increases and a large amount of air is supplied with the same blowing force.

At this time, the indoor air downwardly moved by the fan 14 and the water upwardly moved by the ribs 30 are mixed with each other and, therefore, the contact area therebetween is maximized.

Since the amount of air to be contacted with the water increases, the indoor air can be purified in a short period of time, thereby improving a cleaning efficiency.

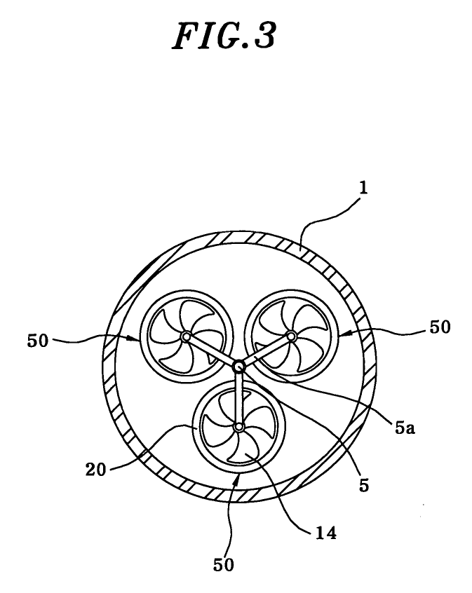

FIG. 3 provides a top view of the cleaning units 50 in accordance with a third preferred embodiment of the present invention.

As same as the first preferred embodiment, the third preferred embodiment of the present invention includes the blowing unit 10 and the guide 20. However, the third preferred embodiment is characterized in that a plurality of cleaning units are installed in the air cleaner and simultaneously operated. As described in FIG. 3, three cleaning units are installed at a rod 5a rotating with the rotation shaft 5, the rod 5a being connected by a gear to the rotation shaft 5 installed at a center of the housing 1. Thus, if the rotation shaft 5 rotates, three cleaning units 50 are simultaneously driven. Accordingly, a whirlpool is not generated in the water stored in the housing 1. Further, in comparison with the first preferred embodiment having a single cleaning unit of high capacity, a blowing amount is not reduced, so that it is possible to achieve an air cleaner with a reduced noise.

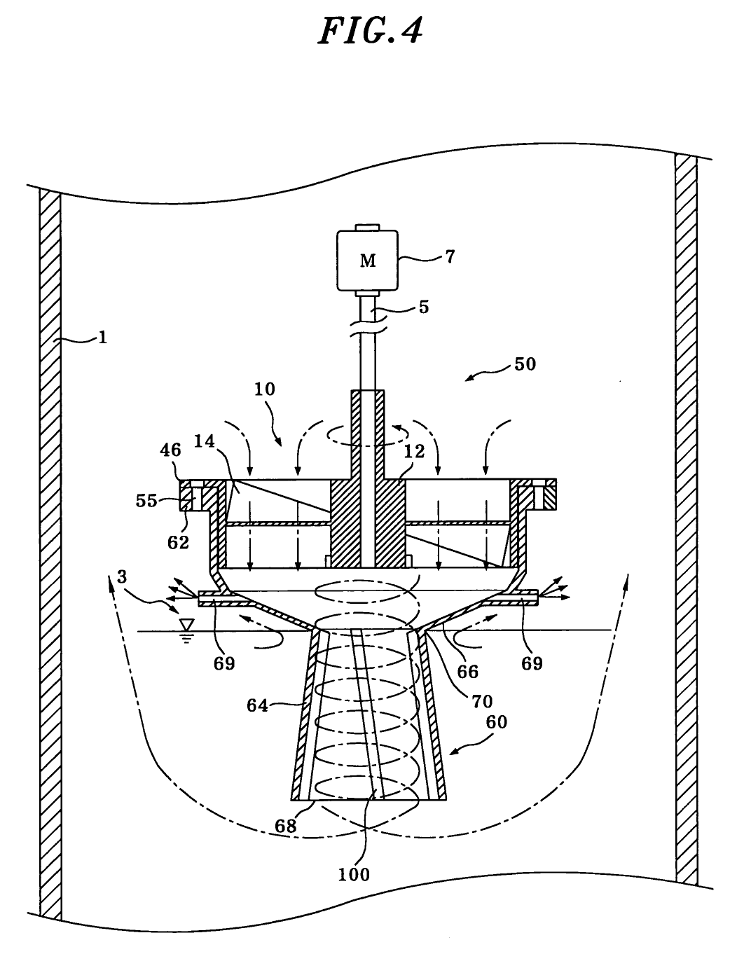

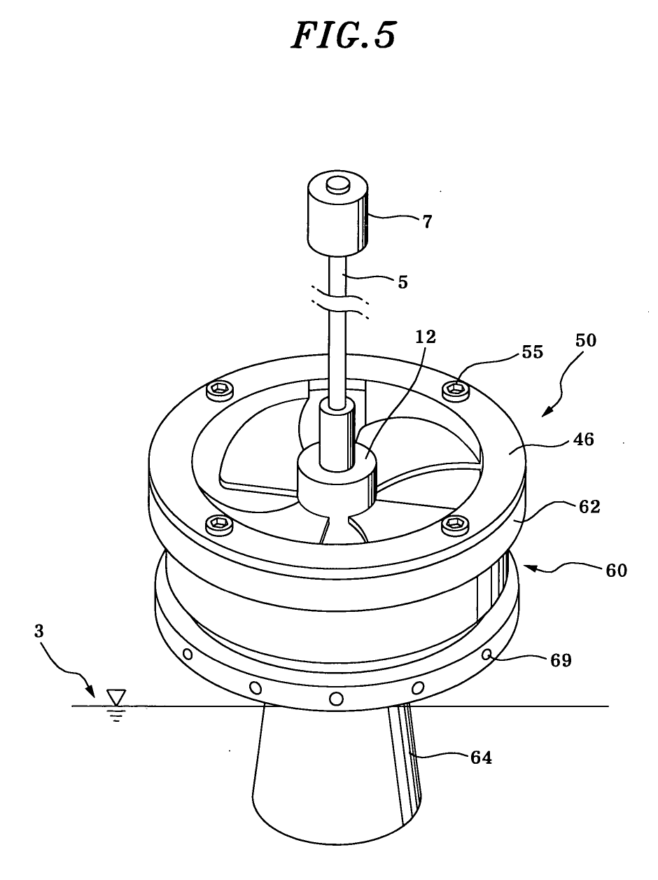

Hereinafter, a fourth preferred embodiment of the present invention will be described with reference to FIGS. 4 and 5. Parts or structures identical to those described in the first preferred embodiment will be assigned like reference numerals, and description thereof will be omitted.

A lower portion of a guide 60 having an inner cross sectional area changing in a longitudinal direction is submerged into the water 3 of the housing 1.

An upper coupling unit 46 having therein coupling holes is provided at a frame surrounding an outer portion of the fan 14. Further, another coupling holes are provided at a lower coupling unit 62 of the guide 60, and the lower coupling unit 62 is coupled with the upper coupling unit 46 by a screw 55 inserted into the coupling holes of the lower coupling unit 62 and the upper coupling unit 46.

The guide 60 rotates with the blowing unit 10 while being coupled therewith, and the lower portion of the guide 60 is outwardly inclined. An outlet opening 68 having a wide cross sectional area is provided at a bottom end of the guide 60. Further, a lower inclined portion 64 is installed so that a cross sectional area thereof becomes narrower toward an upper portion.

Formed at an upper portion of the lower inclined portion 64 is an upper inclined portion 66 inclined outwardly at a predetermined angle, the upper inclined portion 66 having a cross sectional area becoming wider toward an upper portion thereof.

A rib 100 is formed on an inner surface of the lower inclined portion 64. When the guide 60 rotates, the rib 100 enables water in the lower inclined portion 64 to be mixed with air and then upwardly moved. Further, due to the rib 100 made of a spiral protrusion, when the guide 60 rotates, water can be upwardly transferred along the inclined surface of the rib 100 by the centrifugal force.

Moreover, injection holes 69 protruded sideways are provided at a circumferential surface of the upper inclined portion 66. Accordingly, when the guide 60 rotates, the water in the guide 60 is moved toward an inner wall of the guide 60 by the centrifugal force and then upwardly transferred. Next, the water is sprayed from the injection holes 69 to outside of the guide 60 and then contacted with the air passing through the water, so that toxic substances in the air can be further adsorbed.

Hereinafter, an operation of the air cleaner in accordance with the present invention will be described.

A rotary power generated by the motor 7 is transferred to the rotating engagement 12 of the blowing unit 10 via the rotation shaft 5.

Accordingly, the blowing unit 10 rotates and, further, the fan 14 formed as a unit therewith introduces air above the blowing unit 10 and then transfers the introduced air to a lower side of the blowing unit 10.

At this time, due to a rotation of the rib 100 formed on the inner surface of the lower guide portion 64, the water is mixed with the air transferred by the fan 14 and then upwardly dispersed. Accordingly, the contact area increases, thereby facilitating an adsorption of toxic substances.

The air whose toxic substances have been removed by a first contact is supplied into the water and discharged through an outlet opening 68. While the discharged air passes through the water, the air is contacted with the water secondarily.

Here, as shown in FIG. 4, the water in the guide 60 is sprayed to outside of the guide 60 through the injection holes 69 and thus thirdly contacted with the air passing through the water.

At this time, since the water is upwardly transferred along the guide 60 and sprayed through the injection holes 69 while being formed in a whirlpool shape by the rib 100 provided at the inner surface of the lower guide portion 64, the centrifugal force is approximately doubled and a water injection speed increases, thereby resulting in a maximized contact area.

In case water is finely sprayed from the injection holes 69, a large amount of air with negative ions is generated due to the Lenard effect. The amount of air with the negative ions is greater than negative ions generated by a high-pressure discharge and, also, such generated air with the negative ions is close to a natural state.

When the guide 60 and the fan 14 rotate as a unit, water flowing along the upper inclined portion 66 is upwardly transferred by the centrifugal force, and air containing water particles are downwardly moved by the blowing force of the fan 14.

The air, containing water particles, flowing along the upper inclined portion 66 is transferred toward the outlet opening 68 by the centrifugal force along the lower inclined portion 64. At this time, droplets or water particles in the air are mixed with the water 3 in the housing 1 and, then, only clean air is risen above the water through the outlet opening 68.

The aforementioned water and air passing through the lower inclined portion 64 are mixed with each other by the centrifugal force generated by the rotation of the guide, so that foreign substances in the air can be collected by water, and then removed.

In the cleaning unit in accordance with the present invention, the cleaning unit provided with a fan and a guide is connected to a rotation shaft of a blowing unit and the guide is so installed as to be submerged into water. Thus, when the blowing unit of the air cleaner is driven, air introduced into a housing is transferred into the water, thereby maximizing a contact area between indoor air and the water upwardly moved by a rib. Accordingly, foreign substances in the air can be effectively adsorbed, and pleasant indoor environment can be created.

Due to the guide and the rib, the air and the water are primarily contacted in the housing. Next, the water sprayed through the injection holes and the air are secondarily contacted in the water of the housing, the injection holes being provided at a circumferential surface of the guide. Accordingly, since the air and the water is mixed with each other in several time, it is possible to effectively adsorb the toxic substances.

Further, since there is no additional driving unit for driving the cleaning unit, the number of components is reduced, which reduces a cost of the air cleaner.

Furthermore, since the water is not dispersed and the indoor air is transferred into the water, it is possible to reduce a noise generated by a collision of the water on the inner wall of the housing. As a result, pleasant indoor environment with reduced foreign substances can be maintained, and quiet indoor atmosphere can also be obtained.

Moreover, after the cleaning operation is performed by supplying the indoor air into the water without dispersing the water, the air dispersed to outside of the water is discharged into a room. Consequently, a humidity level of a natural state in the indoor air can be constantly maintained. Further, by preventing the water from being discharged through the injection holes, more pleasant indoor environment can be achieved.

While the invention has been shown and described with respect to the preferred embodiments, it will be understood by those skilled in the art that various changes and modification may be made without departing from the scope of the invention as defined in the following claims.

What is claimed is:

1. A cleaning unit for a wet type air cleaner, comprising:
a blowing unit rotatably installed in a housing containing therein water, for introducing indoor air toward the water;
a guide extended from a lower end of the blowing unit into the water, for supplying the indoor air into the water; and
a plurality of ribs provided at an inner surface of the guide, for dispersing the water in the housing by a centrifugal force of the blowing unit,
wherein the blowing unit and the guide are rotated as a unit, and a contact area between the water upwardly moved by the ribs in the guide and the indoor air introduced by the blowing unit becomes maximum.

2. The cleaning unit of claim 1, wherein the blowing unit includes a motor serving as a driving unit; a rotation shaft transferring a rotary power of the motor; and a fan connected with the rotation shaft, for rotating with the blowing unit.

3. The cleaning unit of claim 1, wherein the guide downwardly extended from an outer end of the blowing unit is formed in a hollow cylindrical shape, the guide having an inner cross sectional area changing in a longitudinal direction.

4. The cleaning unit of claim 3, wherein the guide has an upper portion narrower than a lower portion thereof.

5. The cleaning unit of claim 1, wherein the guide is formed by overlapping a plurality of guides having different diameters while maintaining at regular intervals there-between.

6. The cleaning unit of claim 1, wherein a plurality of cleaning units is installed in parallel in the housing, and is simultaneously driven while being connected to the rotation shaft by a gear.

7. The cleaning unit of claim 1, wherein each of the ribs is a spiral protrusion.

8. A cleaning unit for a wet type air cleaner, comprising:
a blowing unit rotatably installed in a housing containing therein water, for introducing indoor air toward the water;
a guide extended from a lower end of the blowing unit into the water, for supplying the indoor air into the water; and
a plurality of ribs provided at an inner surface of the guide, for dispersing the water in the guide by a centrifugal force of the blowing unit; and
injection holes provided at a circumferential surface of the guide, for spraying the water dispersed by the ribs to outside of the guide, wherein the blowing unit and the guide are rotated as a unit.

9. The cleaning unit of claim 8, wherein the blowing unit includes a motor serving as a driving unit; a rotation shaft transmitting a rotary power of the motor; and a fan connected with the rotation shaft, for rotating with the blowing unit.

10. The cleaning unit of claim 8, wherein the guide is provided with a plurality of ribs formed on an inner surface of the guide.

11. The cleaning unit of claim 8, wherein the guide includes a lower inclined portion having a cross sectional area becoming narrower from a lower portion to a upper portion thereof in a longitudinal direction; an upper inclined portion having a cross sectional area becoming wider from a lower portion to a upper portion thereof; and a bent portion having a minimum cross sectional area obtained by connecting the lower end of the upper inclined portion and the upper end of the lower inclined portion.

12. The cleaning unit of claim 10, wherein each of the ribs is a spiral protrusion.

13. A wet type air cleaner comprising the cleaning unit described in claim 1.

14. A wet type air cleaner comprising the cleaning unit described in claim 8.
